(19) United States
(12) Patent Application Publication
(10) Pub. No.: US 2004/0157548 A1
(43) Pub. Date: Aug. 12, 2004

(54) Home network interface legacy device adapter

(76) Inventor: Mark Kenneth Eyer, Woodinville, WA (US)

Correspondence Address: Jan Carol Little, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/692,616

(22) Filed: Oct. 24, 2003

Related U.S. Application Data
(60) Provisional application No. 60/445,995, filed on Feb. 6, 2003.

(51) Int. Cl. H04H 7/00

(52) U.S. Cl. 455/3.06; 455/556.1

(57) ABSTRACT

Embodiments of the present invention include a method and apparatus for using, operating, and controlling audio/video equipment in a wired or wireless home network using a remote control unit. One embodiment of the invention allows legacy audio/video devices to be included in the home network. An adapter converts analog video and analog audio to digital from one device, multiplexes the digital signals, and converts the multiplexed signal to a format compatible with the home network transmission medium. The adapter also de-multiplexes and converts digital signals back into analog video and analog audio. The adapter also conveys optical pulses from a legacy device's remote control unit across the network.

### RELATED APPLICATION

The present application claims the benefit of priority on U.S. Provisional Application No. 60/445,995, filed Feb. 6, 2003.

### TECHNICAL FIELD

Embodiments of the present invention relate to home network entertainment systems and, in particular, to home networking of legacy audio/video devices.

### BACKGROUND

It is common for many homes to have several audio/video devices located throughout the house. For example, it is common for many homes to have a digital versatile disc (DVD) player in the downstairs family room, a personal video recorder (PVR) such as Tivo® or Replay TV® in the upstairs master bedroom, a surveillance camera for the perimeter of the home, one or more digital televisions (DTV) in the other bedrooms, kitchen, etc. In newer homes, the audio/video devices may be connected to each other in a “home network” in that the audio/video devices are connected via a common communication interface. There are limitations in the current technology, however.

One limitation is that many “legacy” audio/video devices cannot communicate with each other or with state-of-the-art audio/video devices across the newer digital transmission media. This is because legacy audio/video devices transmit and receive audio and video in analog form only. For example, many legacy video display devices input and output only composite National Television Standards Committee (NTSC) signals, S-video signals, or component analog video signals. Similarly, many legacy audio devices input and output only baseband analog stereo audio signals.

This can be problematic when attempting to interface such audio/video devices with each other in a home network because state-of-the-art home network transmission media is digital-based. The inability to interface the legacy audio/video devices with digital transmission media is a challenge to further development of home networking technology. Users are forced to re-purchase new models of existing functional equipment in order to make use of it in a networked environment.

To illustrate another limitation, suppose a homeowner wants to watch a DVD on the digital television in the master bedroom. The homeowner takes the remote control unit for the DVD player to the master bedroom and attempts to remotely operate the DVD player located in the family room. Unfortunately, remote control units designed using infrared technology may require line-of-sight visibility with their target device. Thus, to control the DVD player from the master bedroom, the remote control unit for the DVD player must have line-of-sight visibility with the DVD player, which is not possible when the remote control unit is in the master bedroom.

To highlight still another limitation, remote control units designed using current known technology are typically programmed to control devices manufactured by their common company but not to control devices manufactured by other companies. This means that if the remote control unit that controls the DVD player were manufactured by one company and the digital television were manufactured by another company, the remote control for the DVD player would be programmed to control the DVD player in the family room, but it could not control the digital television in the master bedroom. Similarly, the remote control for the digital television would be programmed to control the digital television in the master bedroom, but it could not control the DVD in the downstairs family room.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a home network according to embodiments of the present invention;

FIG. 2 is a high-level block diagram of the network adapter depicted in FIG. 1 according to an embodiment of the present invention;

FIG. 3 is a timing diagram showing an example data code sequence according to an embodiment of the present invention;

FIG. 4 illustrates an example representation of the data code sequence depicted in FIG. 3 according to an embodiment of the present invention;

FIG. 5 is a flowchart illustrating an approach to operating a home network according to an embodiment of the present invention; and

FIG. 6 is a high-level block diagram of the network interface illustrated in FIG. 1 according to an embodiment of the present invention.

### DETAILED DESCRIPTION OF THE ILLUSTRATED EMBODIMENTS

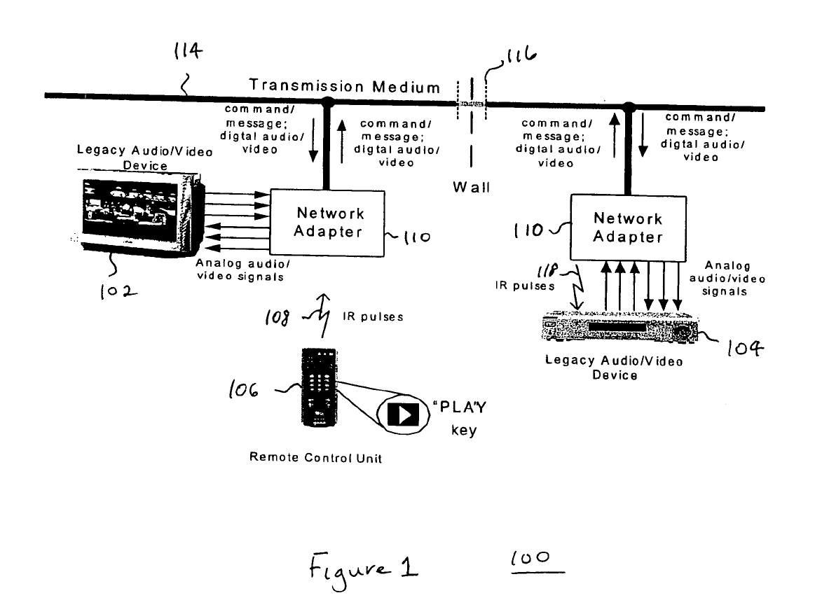

FIG. 1 is high-level schematic diagram of a home network 100 according to an embodiment of the present invention. The home network 100 includes a first device 102, a second device 104, and a remote control unit 106 that emits a signal 108. These devices 102 and 104 are each coupled to two legacy network adapters 110. Each network adapter 110 is coupled to a transmission medium 114 and positioned on opposite sides of a wall 116. As a result, the remote control unit 106 has line-of-sight visibility with the network adapter 110 coupled to the device 102, but not with the network adapter 110 coupled to the device 104. The remote control unit 106 may have line-of-sight visibility with the device 102, but it does not have line-of-sight visibility with the device 104.

Illustrative embodiments of devices 102 and 104 may include various types of consumer audio/video devices and equipment. It is understood that an “audio/video device” refers to any device that transmits and/or receives audio and/or video through wired and/or wireless means. For purposes of illustration, the device 102 is depicted as a display unit. However, embodiments of the present invention are not so limited. Suitable audio/video devices include, but are not limited, to set-top boxes such as those on the premises of cable, satellite, and terrestrial broadcast service subscribers, televisions such as digital television (DTV) displays, compact disk (CD) players/recorders, digital video disc (DVD) receivers/displays, surveillance cameras, personal video recorders such as Tivo®, radios, video-cassette recorders/players (VCR), and digital recorders/players.

An illustrative embodiment of the remote control unit 106 includes any controller that can emit an optical signal, such as infrared (IR) pulses. The remote control unit 106 has a number of keys (e.g., PLAY) that may be depressed to support a number of functions. For example, the remote control unit 106 includes keys which, when depressed, allow the user to issue specific commands, such as power on, channel selection, volume selection, skip, rewind, stop, etc.

The remote control unit 106 is programmed to communicate with the second device 104. The network adapters 110 pass infrared pulses to the device 104.

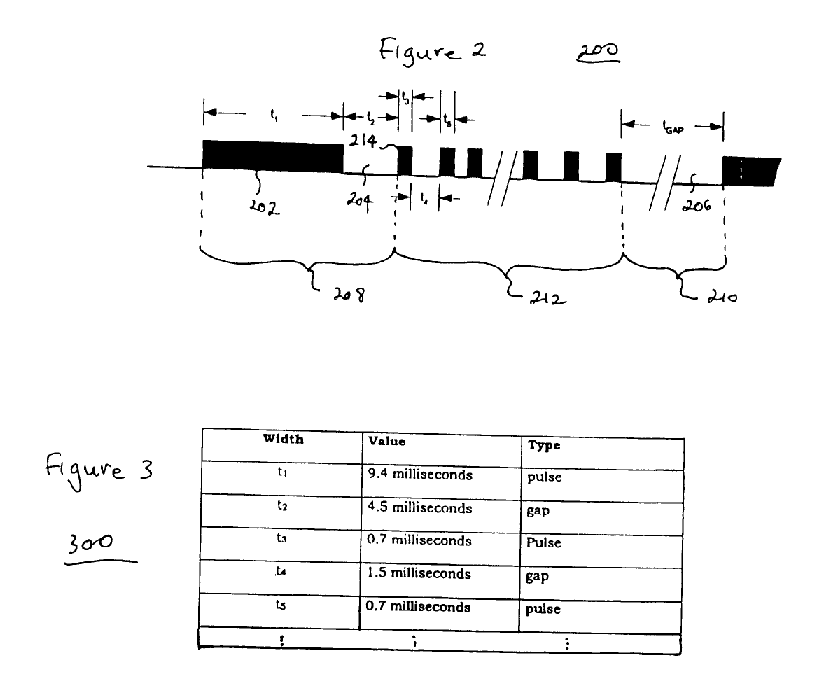

The remote control unit 106 may be programmed such that the signal 108 includes a data code sequence for communicating with the device 104. FIG. 2 is a timing diagram showing an example data code sequence 200 according to an embodiment of the present invention. The example data code sequence 200 includes several pulses having specific pulse widths. Each pulse is separated from the next with gaps of specific widths. For example, a pulse 202 has a width t₁, of six to ten milliseconds and a gap 204 has a width t₂ of four to seven milliseconds. The data code sequence 200 also includes a gap 206 having a width of T_{GAP} milliseconds. In one embodiment, the width t₁, may be in the range of approximately nine to eleven milliseconds and the width t₂ may be in the range of approximately four to six milliseconds.

The combination of the pulse 202 and the gap 204 may represent a “start sequence” 208. When the device 104 is in the line-of-sight of the remote control unit 106 and encounters the example start sequence 208, the device 104 recognizes that particular start sequence 208 and anticipates the beginning of the data code sequence 200.

The gap 206 may represent an “end sequence” 210. In one embodiment, the gap 206 is longer than a predetermined threshold value, thus terminating the example data code sequence 200. When the device 104 is in the line-of-sight of the remote control unit 106 and encounters the example gap 206, the device 104 recognizes that it represents the end of the data code sequence 200.

The data code sequence 200 also may include binary data bits that form a message/command 212 for the device 104. The message/command 212 may be inserted between the start sequence 208 and the end sequence 210. The example binary data bits may start at a pulse 214. In one embodiment, a short pulse followed by a short gap may indicate a logic level “0” and a short pulse followed by a longer gap may indicate a logic level “1.”

It is to be understood that the network adapter 110 coupled to the device 102 does not recognize the data code sequence 200 and does not respond to messages or perform commands included in the data code sequence 200. This is because the communication protocol of the network adapter 110 is different from the communication protocol of the remote control unit 106. Moreover, in contrast to other technologies that operate based on the assumption that devices in a network utilize a common communication protocol, embodiments of the present invention operate based on the assumption that devices in the home network 100 utilize dissimilar communication protocols.

Recall from above that there is no line-of-sight communication between the remote control unit 106 and the device 104 and that the remote control unit 106 is not programmed to communicate with the network adapter 110 coupled to the device 102. In embodiments of the present invention, the remote control unit 106 can control the device 104 despite the fact that the remote control unit 106 does not have line-of-sight communication with the device 104 and despite the fact that the remote control unit 106 is not programmed for communicating with the network adapter 110 coupled to the device 102. As a result, when the user presses a key on the remote control unit 106, the device 104 responds appropriately (e.g., plays a DVD, skips a track on a CD, rewinds a tape, etc.).

In one embodiment of the present invention, the network adapter 110 coupled to the device 102 generates a representation of the example data code sequence 200. FIG. 3 illustrates an example representation 300 of the data code sequence 200 (e.g., a list of collected sample values) according to an embodiment of the present invention. The example representation 300 of the data code sequence 200 lists the contents of the data code sequence 200 including the duration and type for the pulses and gaps in the data code sequence 200.

The network adapter 110 coupled to the device 102 transfers the representation of the data code sequence 300 onto the transmission medium 114. The network adapter 110 coupled to the device 104 receives the representation of the data code sequence 300 from the transmission medium 114 and transfers the representation of the data code sequence 300 to the device 104. The device 104 may device responds to the message and/or performs commands in the representation of the data code sequence 300, e.g., turns “on,” turns “off,” changes channel, changes volume, etc.

Although the remote control unit 106 is depicted as a typical hand-held remote control unit, embodiments of the present invention are not so limited. For example, the remote control unit 106 may be an IR keyboard or personal digital assistant (PDA).

In one embodiment, the signal 108 may be a pulse width modulated (PWM) infrared optical signal having a modulation frequency of approximately thirty-eight (38) kilohertz (kHz). The carrier may be modulated at higher or lower rates in other embodiments. For example, the carrier may be modulated at a frequency selected from a range of approximately thirty kilohertz (30 kHz) to four hundred fifty-five (455) kHz or more. The signal 108 carries the commands/messages, such as power on, channel selection, volume selection, skip, rewind, stop, etc., to control the device 102, the device 104, and the network adapters 110.

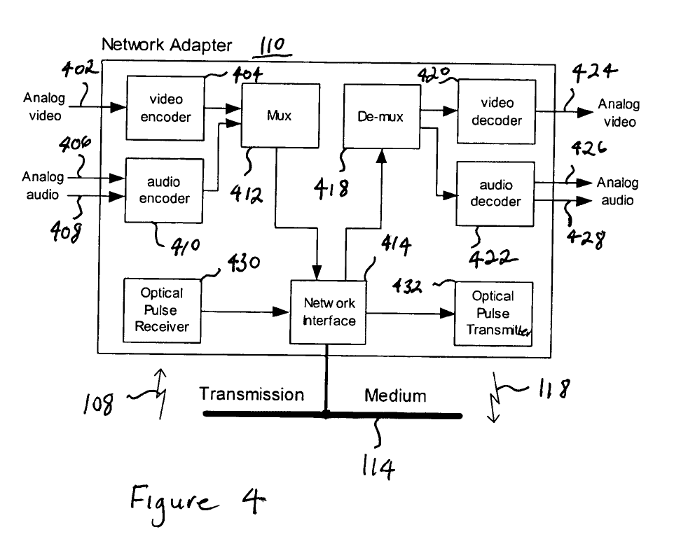

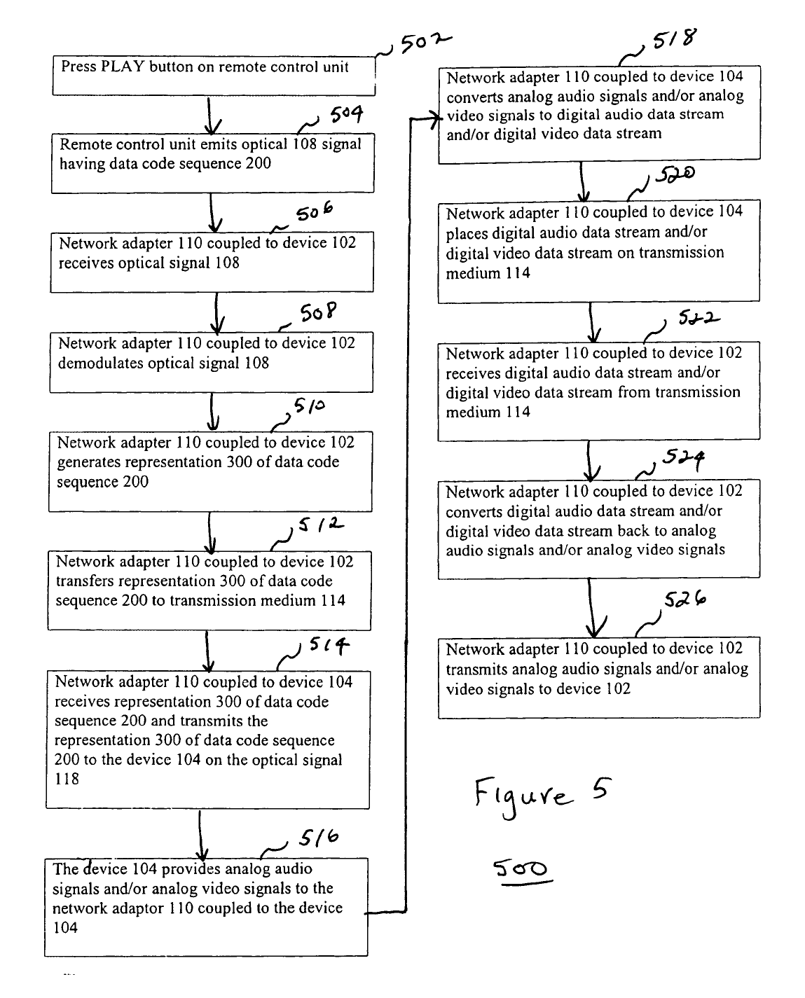

FIG. 4 is a high-level block diagram of a network adapter 110 according to an embodiment of the present invention. The illustrated network adapter 110 includes an analog video signal input 402 that is coupled to a video encoder 404. The analog video signal may be a composite National Television Standards Committee (NTSC) signal, an S-video signal, or a component analog video signal.

The video encoder 404 converts the analog video signal on the analog video input 402 into a digital video data stream. The video encoder 404 may be a Moving Pictures Experts Group (MPEG) encoder, a DV encoder, or similar digital video encoder. The digital video data stream may be an MPEG video data stream such as an MPEG-4 Part 10 video signal, an MPEG-2 digital video data stream, a digital video formatted (DV) video data stream, or similar digital video data stream.

The illustrated network adapter 110 includes a first analog video signal input 406 and a second analog video signal input 408 that are coupled to an audio encoder 410. The analog audio signal may be a baseband analog stereo audio signal.

The audio encoder 410 converts the analog audio signal on the analog audio inputs 406 and 408 into a digital audio data stream. The digital audio data stream may be an MPEG audio signal such as an MPEG-2 audio data stream or an MPEG-1 Layer 3 (so-called “MP-3”) audio data stream, a Dolby audio data stream, pulse code modulated (PCM) samples of the analog audio data stream, or other suitable digital audio data stream.

The illustrated network adapter 110 includes a multiplexer 412 that may multiplex the digital video data stream and the digital audio data stream together. The network adapter 110 may couple the multiplexed digital data stream to a network interface 414.

In one embodiment, the network interface 414 may convert the multiplexed digital signal into format compatible with the electrical characteristics of the transmission medium 114. In one embodiment, the transmission medium 114 is an IEEE 1394 Serial Bus as defined by the well-known Institute of Electrical and Electronics Engineers (IEEE) Standard 1394. In an alternative embodiment, the transmission medium 114 is a well-known Ethernet transmission medium. In still other embodiments, the transmission medium 114 is a wireless transmission medium, an optical fiber, a twisted pair, or other suitable transmission medium. For example, the transmission medium may be compatible with a Bluetooth protocol, or any one of the well known Institute of Electrical and Electronics Engineers (IEEE) 802.11 Standard transmission medium (e.g., IEEE 802.11a, IEEE 802.11b, IEEE 802.11e, IEEE 802.11g) protocols.

The network interface 414 also may receive a multiplexed digital data stream from the transmission medium 114. The illustrated network adapter 110 includes a de-multiplexer 418 that may separate a digital video data stream from a digital audio data stream if they are received as a multiplexed digital signal from the transmission medium 114.

The network adapter 110 in the illustrated embodiment includes a video decoder 420 and an audio decoder 422 coupled to the de-multiplexer 418. The video decoder 420 converts the digital video data stream to an analog video signal. The audio decoder 424 converts the digital audio data stream to an analog audio signal. The video decoder 420 may be an MPEG decoder, a DV decoder, or similar digital video decoder. The audio decoder 220 may be an MPEG audio decoder such as an MPEG-2 decoder or an MP-3 decoder, a Dolby Digital™ decoder, a pulse code demodulator, or other suitable digital audio decoder.

The illustrated network adapter 110 includes an analog video signal output 424 coupled to the video decoder 420. The analog video signal output 424 couples an analog video signal to the legacy device 104.

The illustrated network adapter 110 includes two analog audio signal outputs 426 and 428 coupled to the analog audio decoder 422. The analog audio signal outputs 426 and 428 couple analog audio signals to the legacy device 104.

In one embodiment of the present invention, the network adapter 110 includes an optical pulse receiver 430 coupled to the network interface 414. The optical pulse receiver 430 may receive the optical signal 108 that has the data code sequence 200, including the commands/messages, such as power on, channel selection, volume selection, skip, rewind, stop, etc., to control the device 104. Optical receivers suitable for implementing the optical receiver 430 are known and typically include a photodiode appropriately responsive to the infrared energy, an amplifier, a filter responsive to the carrier frequency used, etc.

The network interface 414 may demodulate the signal 108 from the optical pulse receiver 430 to recover the data code sequence 200 using known optical signal demodulation techniques. In one embodiment, the demodulator removes a carrier that is amplitude modulated at a frequency of thirty-eight kHz to recover the data code sequence 200.

The network adapter 110 also may include other circuitry commonly used to processes commands/messages and streaming video/audio. For example, the network adapter 110 may include circuitry that buffer the video/audio maintain a continuous stream of audio and video to the device 104 without noticeable interruption, etc.

The network adapter 110 also may include an optical pulse transmitter 432 coupled to the network interface 414. The optical pulse transmitter 432 may convert the multiplexed digital data stream into the optical signal 118 and emit the optical signal 118 to control the device 104. Optical pulse transmitters suitable for implementing the optical pulse transmitter 432 are known and typically include a light emitting diode (LED) appropriately modulated to the appropriate modulation frequency, an amplifier, a filter, etc., by the serial data stream generated by the network interface 414.

Although for ease of explanation the network adapters 110 are depicted as having audio/video outputs and audio/video inputs, it is to be understood that a network adapter implemented according to embodiments of the present invention may include only an audio input, only an audio output, only a video input, only a video output, or any combination thereof. Additionally, a network adapter implemented in accordance with embodiments of the present invention may only receive one or more analog signals from a legacy audio/video device, convert the analog signals to one or more digital data streams, and place the digital data streams on the transmission medium 114. Similarly, a network adapter implemented in accordance with embodiments of the present invention may only receive one or more digital data streams from the transmission medium 114, convert the digital data streams to analog signals to one or more, and transfer the analog signals to a legacy audio/video device.

As FIG. 1 and FIG. 4 illustrate, the network adapter 110 may include only an optical/IR pulse input (network adapter 110 coupled to the device 102 as illustrated in FIG. 1), only an optical/IR pulse output (network adapter 110 coupled to the device 102 as illustrated in FIG. 1), or both an optical/IR pulse input and an optical/IR pulse output as illustrated in FIG. 4.

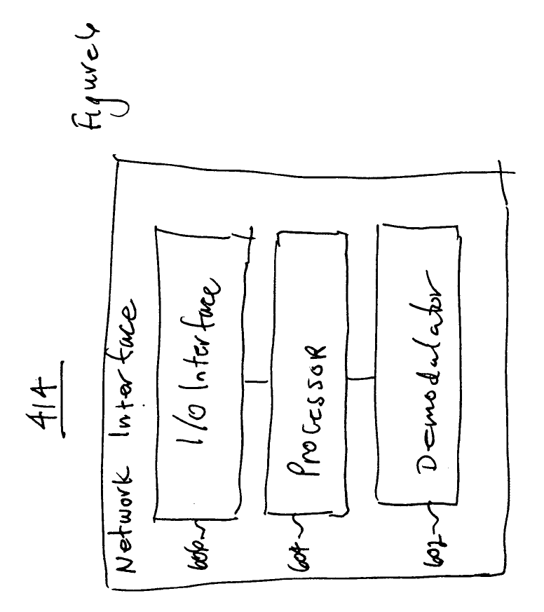

FIG. 5 is a flowchart illustrating a process for operating the home network 100 according to an embodiment of the present invention. A machine-accessible medium with machine-readable instructions thereon may be used to cause a machine to perform the process 500. Of course, the process 500 is only an example process and other processes may be used to implement embodiments of the present invention. The operations of the process 500 are described as multiple discrete blocks performed in turn in a manner that is most helpful in understanding embodiments of the invention. However, the order in which they are described should not be construed to imply that these operations are necessarily order dependent or that the operations be performed in the order in which the blocks are presented.

For purposes of illustration, suppose the homeowner wants to play a DVD (video and audio), a surveillance camera (video only), or CD (audio only) on the device 104 and watch the movie or surveillance video, or listen to the CD on the device 102.

In a block 502, the homeowner presses the PLAY button on the remote control unit 106.

In a block 504, the remote control unit 106 emits the optical signal 108 having the data code sequence 200.

In a block 506, the network adapter 110 coupled to the device 102 receives the optical signal 108.

In a block 508, the network adapter 110 coupled to the device 102 demodulates the optical signal 108.

In a block 510, the network adapter 110 coupled to the device 102 generates the representation 300 of the data code sequence 200, using the measurements (samples) of the data code sequence, for example.

In a block 512, the network adapter 110 coupled to the device 102 transfers the representation 300 of the data code sequence 200 to the transmission medium 114. The network adapter 110 coupled to the device 102 may broadcast the representation 300 of the data code sequence 200 having the PLAY command on the transmission medium 114 or address the representation 300 of the data code sequence 200 having the PLAY command specifically to the device 104.

In a block 514, the network adapter 110 coupled to the device 104 receives the representation 300 of the data code sequence 200 having the PLAY command from the transmission medium 114 and transmits the representation 300 of the data code sequence 200 having the PLAY command to the device 104 on the optical signal 118.

In a block 516, the device 104 provides analog audio signals and/or analog video signals to the network adapter 110 coupled to the device 104. In one embodiment, the device 104 provides a composite National Television Standards Committee (NTSC) signal, an S-video signal, or a component analog video signal to the network adapter 110 coupled to the device 104. In another embodiment, the device 104 delivers a baseband analog stereo audio signal to the network adapter 110 coupled to the device 104.

In a block 518, the network adapter 110 coupled to the device 104 converts the analog audio signal to a digital audio data stream and converts the analog video signal to a digital video data stream. In embodiments of the present invention, the network adapter 110 coupled to the device 104 converts the analog video signal to an MPEG signal, a DV signal, or similar digital video data stream. In other embodiments, the network adapter 110 coupled to the device 104 converts the analog audio signal to an MPEG audio signal, a Dolby audio signal, a PCM signal, or other suitable digital audio data stream.

In a block 520, the network adapter 110 coupled to the device 104 places the digital video data stream and the digital audio data stream on the transmission medium 114, typically after first combining audio and video into a multiplexed format using the multiplexer 412 according to an embodiment of the present invention.

In a block 522, the network adapter 110 coupled to the device 102 receives the digital video data stream and/or the digital audio data stream from the transmission medium 114.

In a block 524, the network adapter 110 coupled to the device 102 converts the digital video data stream and/or the digital audio data stream back into analog form.

In a block 526, the network adapter 110 coupled to the device 102 transmits the analog video signal and/or the analog audio signal to the device 102. In one embodiment, the analog video signal and the analog audio signal from the movie played by the device 104 can be viewed on the device 102.

FIG. 6 is a high-level block diagram of the network interface 414 according to an embodiment of the present invention. The illustrated network interface 414 includes a demodulator 602 that demodulates the signal received from the optical pulse receiver 430 to recover the data code sequence 200. The demodulator 602 may remove a carrier that is amplitude modulated at a frequency of thirty-eight kHz to recover the data code sequence 200 using known optical signal demodulation techniques.

The illustrated network interface 414 includes a processor 604. The processor 604 may determine the details of the data code sequence 200 (e.g., the format of the binary data bits in the message/command 212, etc.). For example, the processor 604 may measure the width of each pulse and each gap in the example data code sequence 200. The measurements are or may be used to generate the representation 300 of the example data code sequence 200. Of course, other techniques of generating the representation 300 of the data code sequence 200 are possible and after reading the description herein, a person of ordinary skill in the relevant art will readily recognize how to implement other embodiments of the present invention using various other processing techniques.

The illustrated network interface 414 includes an input/output (I/O) interface 606, which receives the representation 300 of the example data code sequence 200 and convert the representation of the example data code sequence 200 into a format compatible with the electrical characteristics of the transmission medium 114.

Embodiments of the present invention may be implemented using hardware, software, or a combination thereof. In implementations using software, the software may be stored on a machine-accessible medium.

A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable and non-recordable media (e.g., read only memory (ROM), random access memory (RAM), magnetic disk storage media, optical storage media, flash memory devices, etc.), as well as electrical, optical, acoustic, or other form of propagated signals (e.g., carrier waves, infrared signals, digital signals, etc.).

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description.

In the above description, numerous specific details, such as particular processes, materials, devices, and so forth, are presented to provide a thorough understanding of embodiments of the invention. One skilled in the relevant art will recognize, however, that embodiments of the present invention can be practiced without one or more of the specific details, or with other methods, components, etc. In other instances, well-known structures or operations are not shown or described in detail to avoid obscuring the understanding of this description.

Reference throughout this specification to “one embodiment” or “an embodiment” means that a particular feature, structure, process, block, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms used in the following claims should not be construed to limit the invention to the specific embodiments disclosed in the specification. Rather, the scope is to be determined entirely by the following claims, which are to be construed in accordance with established doctrines of claim interpretation.

What is claimed is:

1. A system, comprising:
a first legacy device;
a transmission medium;
a second legacy device;
a first network adapter coupled to the first legacy device, the first network adapter having circuitry to receive a data code sequence on infrared pulses, the data code sequence recognized by the second legacy device and to control the second legacy device, the first network adapter having circuitry to generate a representation of the data code sequence from the data code sequence, the first network device to transfer the representation of the data code sequence to the transmission medium; and
a second network adapter coupled to transfer the representation of the data code sequence from the transmission medium to the second legacy device,
the second legacy device having circuitry to transfer an analog audio signal to the second network adapter in response to the representation of the data code sequence,
the second network adapter having circuitry to encode the analog audio signal into a digital audio data stream,
the second network adapter having circuitry to transfer the digital audio data stream to the first network adapter via the transmission medium
the first network adapter having circuitry to decode the digital audio data stream back into the analog audio signal, and circuitry to transfer the analog audio signal to the first legacy device.

2. The system of claim 1, wherein the transmission medium is a wired transmission medium.

3. The system of claim 2, wherein the transmission medium is a twisted pair, an IEEE 1394 Serial Bus, or an Ethernet transmission medium.

4. The system of claim 1, wherein the transmission medium is a wireless transmission medium.

5. The system of claim 1, wherein the wireless transmission medium comprises at least one of a Bluetooth transmission protocol, an 802.11a protocol, an 802.11b protocol, an 802.11e protocol, or an 802.11g protocol.

6. The system of claim 1, wherein the first network adapter includes circuitry coupled to receive the data code sequence via infrared pulses.

7. The system of claim 1, wherein the second network adapter includes circuitry to transmit the representation of the data code sequence to the second legacy device via infrared pulses.

8. The system of claim 7, wherein the second legacy device includes circuitry to receive infrared pulses.

9. The system of claim 1, further comprising a remote control unit to transmit the data code sequence to the first network adapter.

10. The system of claim 1, further comprising a wireless keyboard to transmit the data code sequence to the first network adapter.

11. The system of claim 1, further comprising a personal digital assistant to transmit the data code sequence to the first network adapter.

12. A system, comprising:
a first legacy device;
a transmission medium;
a second legacy device;
a first network adapter coupled to the first legacy device, the first network adapter having circuitry to receive a data code sequence on an optical signal, the data code sequence recognized by a second legacy device and to control the second legacy device, the first network adapter having circuitry to generate a representation of the data code sequence from the data code sequence, the first network device to transfer the representation of the data code sequence to the transmission medium; and
a second network adapter coupled to transfer the representation of the data code sequence from the transmission medium to the second legacy device,
the second legacy device having circuitry to transfer an analog video signal to the second network adapter in response to the representation of the data code sequence,
the second network adapter having circuitry to encode the analog video signal into a digital video data stream,
the second network adapter having circuitry to transfer the digital video data stream to the first network adapter via the transmission medium
the first network adapter having circuitry to decode the digital video data stream back into the analog video signal, and circuitry to transfer the analog video signal to the first legacy device.

13. The system of claim 12, wherein the transmission medium is a wired transmission medium.

14. The system of claim 13, wherein the transmission medium is a twisted pair, an IEEE 1394 Serial Bus, or an Ethernet transmission medium.

15. The system of claim 12, wherein the transmission medium is a wireless transmission medium.

16. The system of claim 15, wherein the wireless transmission medium comprises at least one of a Bluetooth transmission protocol, an 802.11a protocol, an 802.11b protocol, an 802.11e protocol, or an 802.11g protocol.

17. The system of claim 12, wherein the first network adapter includes circuitry coupled to receive the data code sequence via infrared pulses.

18. The system of claim 12, wherein the second network adapter includes circuitry to transmit the representation of the data code sequence to the second legacy device via infrared pulses.

19. The system of claim 12, wherein the second legacy device includes circuitry to receive infrared pulses.

20. The system of claim 12, further comprising a remote control unit to transmit the data code sequence to the first network adapter.

21. The system of claim 12, further comprising a wireless keyboard to transmit the data code sequence to the first network adapter.

22. The system of claim 12, further comprising a personal digital assistant to transmit the data code sequence to the first network adapter.

23. An apparatus, comprising:
circuitry to receive a data code sequence via infrared pulses, the data code sequence recognized by a first legacy device and to control the first legacy device;
circuitry to generate a representation of the data code sequence from the data code sequence;
circuitry to transfer the representation of the data code sequence to a transmission medium;
circuitry to receive a digital audio data stream from the transmission medium;
circuitry to decode the digital audio data stream into an analog audio signal; and
circuitry to transfer the analog audio signal to a second legacy device.

24. An apparatus, comprising:
circuitry to receive a data code sequence via infrared pulses, the data code sequence recognized by a first legacy device and to control the first legacy device;
circuitry to generate a representation of the data code sequence from the data code sequence;
circuitry to transfer the representation of the data code sequence to a transmission medium;
circuitry to receive a digital video data stream from the transmission medium;
circuitry to decode the digital video data stream into an analog video signal; and
circuitry to transfer the analog video signal to a second legacy device.

25. An apparatus, comprising:
circuitry to receive a data code sequence via infrared pulses, the data code sequence recognized by a first legacy device and to control the first legacy device;
circuitry to generate a representation of the data code sequence from the data code sequence;
circuitry to transfer the representation of the data code sequence to a transmission medium;
circuitry to receive a digital audio data stream and a digital video data stream from the transmission medium;
circuitry to decode the digital audio data stream and a digital video data stream into an analog audio signal and an analog video signal, respectively; and
circuitry to transfer the analog audio signal and the analog video signal to a second legacy device.

26. The system of claim 25, further comprising circuitry to multiplex the digital audio data stream with the digital video data stream and to transfer the multiplexed digital audio data stream and digital video data stream to the transmission medium.

27. The system of claim 26, further comprising circuitry to receive the multiplexed digital audio data stream and the digital video data stream from the transmission medium and to de-multiplex the digital audio data stream from the digital video data stream.

28. A method, comprising:
receiving a data code sequence via infrared pulses, the data code sequence recognized by a first legacy device and to control the first legacy device;
generating a representation of the data code sequence from the data code sequence;
transferring the representation of the data code sequence to a transmission medium;
receiving a digital audio data stream and a digital video data stream from the transmission medium;
decoding the digital audio data stream and a digital video data stream into an analog audio signal and an analog video signal, respectively; and
transferring the analog audio signal and the analog video signal to a second legacy device.

29. The system of claim 28, further comprising multiplexing the digital audio data stream with the digital video data stream and transferring the multiplexed digital audio data stream and digital video data stream to the transmission medium.

30. The system of claim 29, further comprising receiving the multiplexed digital audio data stream and the digital video data stream from the transmission medium and de-multiplexer the digital audio data stream from the digital video data stream.

31. A method, comprising:
receiving a data code sequence via infrared pulses, the data code sequence recognized by a first legacy device and to control the first legacy device;
generating a representation of the data code sequence from the data code sequence;
transferring the representation of the data code sequence to a transmission medium;
receiving a digital audio data stream from the transmission medium;
decoding the digital audio data stream into an analog audio signal; and
transferring the analog audio signal to a second legacy device.

32. A method, comprising:
receiving a data code sequence via infrared pulses, the data code sequence recognized by a first legacy device and to control the first legacy device;
generating a representation of the data code sequence from the data code sequence;
transferring the representation of the data code sequence to a transmission medium;
receiving a digital video data stream from the transmission medium;
decoding the digital video data stream into an analog video signal; and
transferring the analog video signal to a second legacy device.

33. A method, comprising:
receiving a data code sequence on infrared pulses, the data code sequence recognized by a first legacy device and to control the first legacy device;
generating a representation of the data code sequence from the data code sequence;
transferring the representation of the data code sequence to a transmission medium;
transferring the representation of the data code sequence from the transmission medium to the first legacy device;
receiving an analog audio signal from the first legacy device in response to the representation of the data code sequence and encoding the analog audio signal into a digital audio data stream and,
transferring the digital audio data stream to the transmission medium;
receiving the digital audio data stream from the transmission medium and decoding the digital audio data stream back into the analog audio signal; and
transferring the analog audio signal to a second legacy device.

34. The method of claim 33, further comprising converting the digital audio data stream into format compatible with the electrical characteristics of the transmission medium.

35. The method of claim 34, further comprising converting the digital audio data stream into format compatible with the electrical characteristics of a twisted pair, an IEEE 1394 Serial Bus, or an Ethernet transmission medium.

36. The method of claim 33, further comprising converting the digital audio data stream into format compatible with the electrical characteristics of a wireless transmission medium.

37. A method, comprising:
receiving a data code sequence on infrared pulses, the data code sequence recognized by a first legacy device and to control the first legacy device;
generating a representation of the data code sequence from the data code sequence;
transferring the representation of the data code sequence to a transmission medium;
transferring the representation of the data code sequence from the transmission medium to the first legacy device;
receiving an analog video signal from the first legacy device in response to the representation of the data code sequence and encoding the analog video signal into a digital video data stream and,
transferring the digital video data stream to the transmission medium;
receiving the digital video data stream from the transmission medium and decoding the digital video data stream back into the analog video signal; and
transferring the analog video signal to a second legacy device.

38. The system of claim 37, further comprising converting the digital video data stream into format compatible with the electrical characteristics of the transmission medium.

39. The system of claim 38, further comprising converting the digital video data stream into format compatible with the electrical characteristics of a twisted pair, an IEEE 1394 Serial Bus, or an Ethernet transmission medium.

40. The system of claim 38, further comprising converting the digital video data stream into format compatible with the electrical characteristics of a wireless transmission medium.

41. The system of claim 40, further comprising converting the digital video data stream into format compatible with the electrical characteristics at least one of a Bluetooth transmission protocol, an 802.11a protocol, an 802.11b protocol, an 802.11e protocol, or an 802.11g protocol.
